(19) United States
(12) Patent Application Publication
(10) Pub. No.: US 2003/0192746 A1
(43) Pub. Date: Oct. 16, 2003

(54) Elevator system and method of controlling same

(76) Inventor: Takao Suzuki, Bunkyo-ku (JP)

Correspondence Address: PAUL A. GUSS, PAUL A. GUSS ATTORNEY AT LAW, 775 S 23RD ST FIRST FLOOR SUITE 2, ARLINGTON, VA, 22202

(21) Appl. No.: 10/200,124

(22) Filed: Jul. 23, 2002

(30) Foreign Application Priority Data
Apr. 10, 2002 (JP) 2002-108390

(51) Int. Cl. B66B 1/34

(52) U.S. Cl. 187/391

(57) ABSTRACT

A control console for controlling an elevator system has a computer board for controlling the elevator system in its entirety and a display monitor with a touch panel function, for displaying data stored in a memory on the computer board. Control data is entered using simulated buttons displayed on a monitor screen of the display monitor. The monitor screen displays a floor height menu for displaying the floor heights of respective floors of a building, an in-console call menu for allowing the operator to make operations similar to those on an elevator car control console, a function menu for setting various functions, a first failure display menu for displaying failures, and a data list menu for displaying various data. The operator enters necessary data in these menus.

### BACKGROUND OF THE INVENTION

1. Field of the Invention

The present invention relates to an elevator system and a method of controlling an elevator system, and more particularly to an elevator system which is controlled by a control console where detected data is displayed and control data is inputted, and a method of controlling such an elevator system.

2. Description of the Related Art

General elevator systems basically comprise an elevator car for carrying human beings or cargo, a counterweight connected to the elevator car by wires looped around a sheave, an electric motor for rotating the sheave, and a control console for controlling the elevator system in its entirety.

The electric motor is controlled by an inverter in the control console to rotate and stop the sheave and also to control the rotational speed of the sheave. The electric motor rotates the sheave to raise and lower the elevator car.

The electric motor has a rotatable shaft associated with an encoder which supplies a signal representing the angular displacement of the electric motor to a computer in the control console. The computer controls the electric motor based on the signal supplied from the encoder.

The computer comprises a microcomputer mounted on a board, and does not have man-machine interfaces including a monitor, a keyboard, etc.

The control console is also supplied with output signals from call buttons in the electric car, buttons on the floors, various limit switches and sensors, as input signals, in addition to the signal from the encoder. The input signals supplied from these buttons, switches, and sensors are processed by the computer.

When a maintenance person for the elevator system observes signals of the elevator system, since the computer has no man-machine interfaces, LEDs (Light-Emitting Diodes) on the computer board to allow the maintenance person to observe signals of the elevator system. However, the LEDs are disadvantageous in that the amount of information displayed by the LEDs is relatively small, and the LEDs may pose visibility and operability problems. Use of the LEDs makes it difficult for the maintenance person to appropriately diagnose the operational status of the elevator system, and causes trouble in maintenance operation.

For example, when the computer detects a failure, it turns on LEDs on the computer board. However, the LEDs on the computer board limit the number of failure types that can be displayed, and only display whether failures have occurred or not, but do not display the frequency of failures and the number of times that failures occur.

Various control data are set up for the operation of the elevator system. Of the various control data, an elevator operation time in an energy saving mode should preferably be modifiable by the keeper of the building which incorporates the elevator system. The maintenance person should preferably be able to modify, at site, tampering prevention data, speech synthesis data, and an earthquake detection process. However, since these control data are described in a source code of the control program run by the computer, the control data can only be modified by those with a professional knowledge such as program developers who can understand program languages. In addition, the process of modifying the control data is complex as it needs to describe a source code, compile the source code, and transfer the complied code, and requires a dedicated terminal for performing these steps.

### SUMMARY OF THE INVENTION

It is therefore an object of the present invention to provide an elevator system which allows data to be set up with a simple control process without the need for a professional knowledge about program languages and program developing apparatus, and which also allows many items of information as to the elevator system to be displayed clearly, and a method of controlling such an elevator system.

Another object of the present invention is to provide an elevator system which is applicable to various buildings ranging from low-rise to high-rise buildings, is of a general-purpose arrangement that is applicable to electric motors of various types operable at various elevating and lowering speeds ranging from low to high speeds, and is constructed of parts including common parts, thereby reducing an inventory of parts required to manufacture the elevator system.

Still another object of the present invention is to provide an elevator system which is capable of displaying and processing many detected and inputted data, for increased convenience for the maintenance of the elevator system.

Yet another object of the present invention is to provide an elevator system which makes it possible to display detected data in a highly visible format such as a graph.

Yet still another object of the present invention is to provide an elevator system which prevents various settings thereof from being tampered with and makes it possible to establish a range of modifiable settings depending on the operator.

A further object of the present invention is to provide an elevator system which permits a control process therefor to be changed depending on the time.

According to the present invention, there is provided an elevator system comprises an electric motor for raising and lowering an elevator car, an operating state detector for detecting an operating state of a system including the elevator car, a controller for controlling the electric motor and converting a signal detected by the operating state detector into detected data, and a display monitor either connected to or disposed in the controller, for displaying the detected data and entering control data used by the controller, the control data being entered by a touch panel function or a pointing device function of the display monitor.

The operating state detector specifically refers to various sensors for detecting states of the elevator system, switches, and an input device.

With the above arrangement, the touch panel function or the pointing device function is used to set data according to a simple process and display many items of information relative to the elevator system. Since the operator can enter desired data by touching simulated buttons and a ten-key pad of simulated numerical buttons displayed in menus, the operator is not required to have a professional knowledge of program languages and developing apparatus therefor.

The display monitor may selectively display on a monitor screen thereof a plurality of detected data display menus for displaying the detected data.

The display monitor may selectively display on a monitor screen thereof a plurality of control data input menus for entering the control data.

With the plural menus selectively displayed on the monitor screen, operations made in the menus are simplified, and many items of information can be displayed or entered.

The detected data may include failure data, and the detected data display menu may display the names of types of failures represented by the failure data and the number of occurrences of the failures.

The detected data may comprise at least one of a position of the elevator car, a speed of the elevator car, an acceleration of the elevator car, a deceleration of the elevator car, a floor access error of the elevator car, the number of times that the elevator car has operated, and a period of time for which the elevator car has operated.

The control data may comprise at least one of a full-occupancy passage setting, an excessive load setting, a standby floor setting, a mischief prevention function setting, a voice guidance function setting, an earthquake detection setting, a maximum speed setting, an acceleration setting, a deceleration setting, an energy saving mode time setting, an extended door opening time setting, a door torque retention time setting, and a brake delaying time setting.

If the display monitor displays on a monitor screen thereof a speed curve of the elevator car in a graph form, then the operator can easily recognize the operating state of the elevator car.

If the display monitor has a password input function to enter a password, and limits menus to be displayed or limits entering of the control data depending on a password which has been entered, then the display monitor can select persons who can operate on the display monitor, and unauthorized manipulation of the displayed menus is prevented.

The controller may have a clock function, and may perform different control processes depending on a time indicated by the clock function.

The control data may be entered using a ten-key pad including simulated numerical buttons “0” through “9”.

The display monitor may enter in an energy saving sleep mode in the absence of an input operation within a predetermined period of time.

According to the present invention, there is also provided an elevator system comprising an electric motor for raising and lowering an elevator car, an operating state detector for detecting an operating state of a system including the elevator car, a controller for controlling the electric motor and converting a signal detected by the operating state detector into detected data, and a display monitor either connected to or disposed in the controller, the controller having a computer board for controlling menus displayed on the display monitor and controlling a maximum elevating and lowering speed of the elevator car in a range from 30 to 600 [m/min] through rotation of the electric motor.

With the above arrangement, the computer board may be of a common structure, reducing an inventory of parts to make up the elevator system. Since the computer board is a single board, the controller is simplified in arrangement.

According to the present invention, there is further provided a method of controlling an elevator system including an electric motor for raising and lowering an elevator car, an operating state detector for detecting an operating state of a system including the elevator car, a controller for controlling the electric motor and converting a signal detected by the operating state detector into detected data, and a display monitor either connected to or disposed in the controller, the method comprising the steps of entering control data used by the controller, rotating the electric motor based on the control data, detecting an operating state of the elevator car, and displaying the detected data on a monitor screen of the display monitor, the step of entering control data comprising the step of entering the control data using a touch panel function or a pointing device function of the display monitor.

The above and other objects, features, and advantages of the present invention will become more apparent from the following description when taken in conjunction with the accompanying drawings in which a preferred embodiment of the present invention is shown by way of illustrative example.

### BRIEF DESCRIPTION OF THE DRAWINGS

FIG. 1 is a schematic perspective view, partly omitted from illustration, an elevator system according to the present invention;

FIG. 2 is a block diagram of the elevator system according to the present invention;

FIG. 3 is a block diagram of a computer board;

FIG. 4 is a perspective view of a control console with front doors being open;

FIG. 5 is a diagram showing a hierarchy of menus displayed on a display monitor;

FIG. 6 is a diagram showing a main menu;

FIG. 7 is a diagram showing a floor height menu;

FIG. 8 is a diagram showing an in-console call menu;

FIG. 9 is a diagram showing a function menu;

FIG. 10 is diagram showing a password menu;

FIG. 11 is diagram showing a password change mode menu which is similar to the password menu with a ten-key pad displayed therein;

FIG. 12 is a diagram showing a first site setting menu;

FIG. 13 is a diagram showing a first auxiliary setting menu;

FIG. 14 is a diagram showing a control time setting menu;

FIG. 15 is a diagram showing a first failure display menu;

FIG. 16 is a diagram showing a second failure display menu;

FIG. 17 is a diagram showing a fourth failure display menu;

FIG. 18 is a diagram showing a fifth failure display menu;

FIG. 19 is a diagram showing an eighth failure display menu;

FIG. 20 is a diagram showing a data list menu; and

FIG. 21 is a diagram showing a graph menu.

### DESCRIPTION OF THE PREFERRED EMBODIMENT

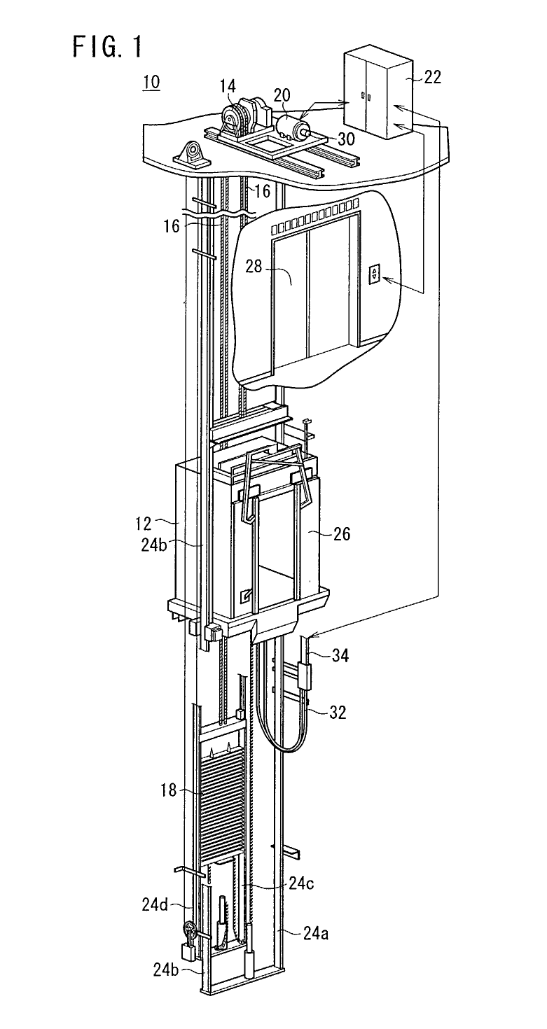

An elevator system and a method of controlling an elevator system according to a preferred embodiment of the present invention will be described below with reference to FIGS. 1 through 21.

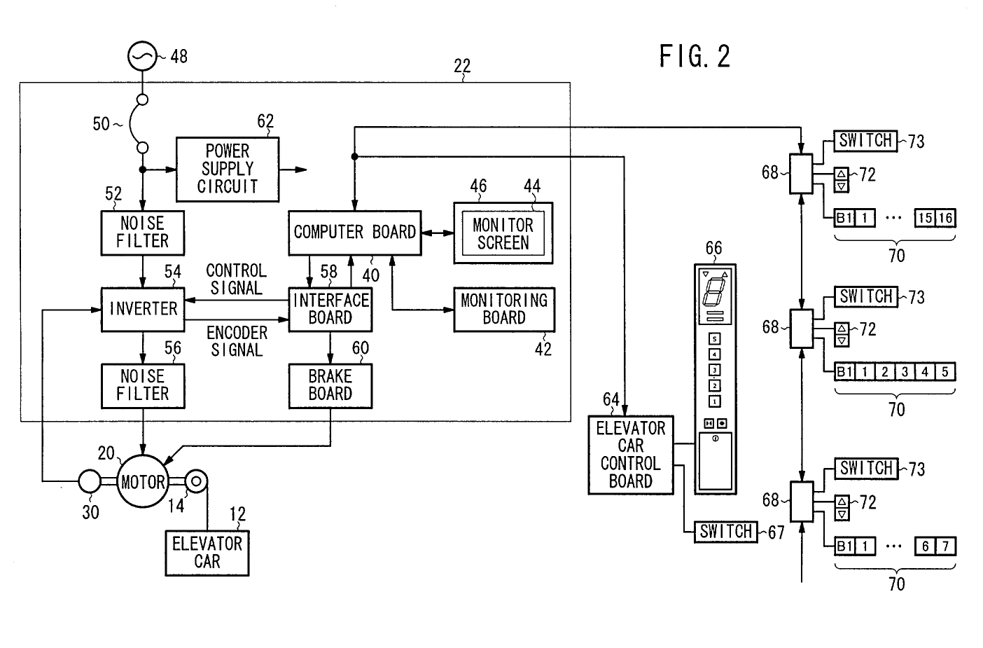

As shown in FIGS. 1 and 2, the elevator system, generally denoted by 10, is a system including an elevator car 12 for vertically carrying human beings and cargo in a building. The elevator system 10 also includes, in addition to the elevator car 12, a counterweight 18 connected to the elevator car 12 by wires 16 trained around a sheave 14, an electric motor 20 for rotating and stopping the sheave 14, and a control console (controller) 22 for controlling the elevator system 10 in its entirety. The elevator system 10 also has a plurality of floor control boards 68 (to be described later on), a plurality of floor indicators 70, a plurality of call buttons 72, a plurality of switches 73, a load sensor (not shown), an earthquake detection sensor (not shown), etc.

The elevator car 12 is lifted and lowered along two guide rails 24a, 24b by the wires 16, and the counterweight 18 is lifted and lowered along two guide rails 24c, 24d.

The elevator car 12 has two car doors 26 on its front side which can be opened and closed horizontally. The car doors 26 are opened and closed in ganged relation to floor doors 28 on the floors under the control of the control console 22.

The electric motor 20 has a rotatable shaft associated with an encoder 30 for detecting an angular displacement of the electric motor 20. A signal produced by the encoder 30 and representing the detected angular displacement of the electric motor 20 is supplied to the control console 22. The control console 22 houses therein a computer board 40 for detecting the height, moving speed, and acceleration/deceleration of the elevator car 12 based on the signal supplied from the encoder 30 via an inverter 54 and an interface board 58.

The elevator car 12 houses therein an elevator car control board 64 which communicates with the control console 22 via a tail cord 32 looped downwardly and a wiring duct 34. The floor control boards 68 and the control console 22 communicate with each other through communication lines.

As shown in FIG. 2, the control console 22 has a computer board 40 as a control means for controlling the control console 22 in its entirety, a monitoring board 42 for monitoring operation of the computer board 40, and a display monitor 46 as a touch panel having a liquid crystal monitor screen (also referred to as “screen”) 44. The control console 22 also has a circuit breaker 50 for connecting and disconnecting a three-phase AC power supply 48, a noise filter 52 for removing noise generated by an inverter 54 which controls rotation of the electric motor 20, and a noise filter 56 for removing output noise from the inverter 54 and supplying electric energy to the electric motor 20. The control console 22 further includes an interface board 58 connected between the computer board 40 and the inverter 54, for transferring signals therebetween, a brake board 60 for braking the electric motor 20, and a power supply circuit 62 for generating DC electric energy from the three-phase AC power supply 48.

The computer board 40 is connected to the elevator car control board 64 in the elevator car 12, and can control an elevator car control console 66 in the elevator car 12 through the elevator car control board 64. The elevator car control board 64 detects signals from a sensor and a switch. For example, the elevator car control board 64 detects a state of a switch 67 which operates in response to the opening/closing movement of the car doors 26, and transmits the detected state to the computer board 40. In FIG. 2, the elevator car control board 64, the elevator car control console 66, and the switch 67 are shown as being separate from the elevator car 12 for illustrative purposes. However, the elevator car control board 64, the elevator car control console 66, and the switch 67 are actually mounted in the elevator car 12.

The computer board 40 is connected to one of the floor control boards 68. The floor control boards 68 are connected in series with each other for communication with the computer board 40.

The floor control boards 68 control the floor indicators 70 and the call buttons 72 on the respective floors. The floor control boards 68 also detect signals from given sensors and switches. For example, the floor control boards 68 detect respective states of the switches 73 that operate in response to the opening/closing movement of the floor doors 28, and transmit the detected states to the computer board 40.

The monitoring board 42 has a so-called watchdog function to determine whether the computer board 40 is operating normally or not. If the computer board 40 is malfunctioning, then the monitoring board 42 issues a warning and performs a related process depending on the malfunction.

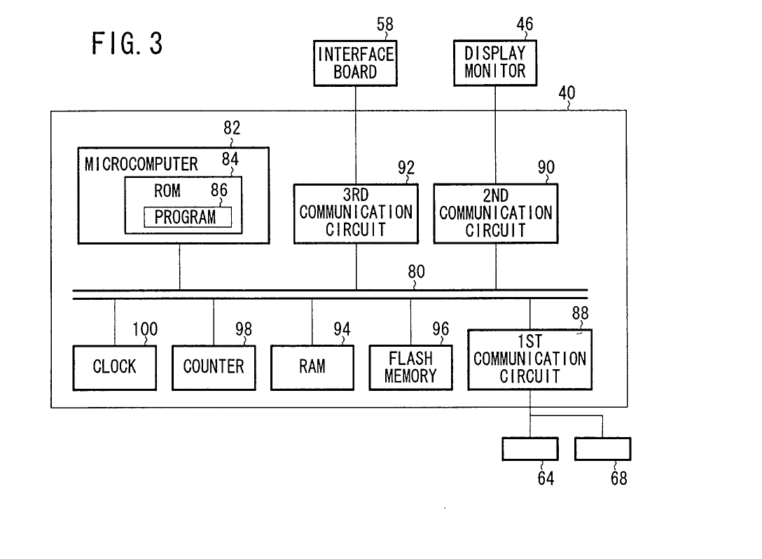

The display monitor 46 has a function as an input/output device of the computer board 40, and displays data stored in a RAM (Random Access Memory) 94 (see FIG. 3), a flash memory 96, etc. on the computer board 40. The display monitor 46 also has a function as a touch panel (also known as “touch screen”) for the operator to enter data by directly touching the monitor screen 44 with a finger. The entered data is supplied to the computer board 40. The touch panel may comprise a pressure-sensitive touch panel or an electrostatic touch panel which may be selected depending on the conditions in which the touch panel is used and the conditions in which the touch panel is designed. The touch panel is highly environment-resistant as it is free of mechanical switches as with a keyboard. Since the operator directly touches the display monitor 44, the operator is not required to be highly skilled in entering data, but may enter data intuitively.

The display monitor 46 also has a function to operate in an energy saving mode. Specifically, when no operation to enter data is made on the display monitor 46 for a given period of time, the display monitor 46 turns off its display, and when the operator touches the monitor screen 44 again, the display monitor 46 turns on its display. Therefore, the electric energy consumed by the display monitor 46 is reduced. The display monitor 46 further includes a resume function (also known as “standby function”) for displaying the same menu as the menu displayed the last time when the menu is displayed again following the energy saving mode. The energy consumption of the display monitor 46 is relatively low as it has a liquid crystal monitor screen.

The input device of the display monitor 46 is not limited to the above touch panel, but may comprise a pointing device which is an input device for specifying an input position or coordinates on the monitor screen, such as a mouse, a track pad, a track ball, or the like.

The interface board 58 sends signals to and receives signals from the computer board 40 and the brake board 60. The interface board 58 also sends signals to and receives signals from the inverter 54 through an insulative element such as a photocoupler. Therefore, the interface board 58 is highly reliable and noise-resistant for communications with the inverter 54. The interface board 58 detects the signal from the encoder 30 via the inverter 54, and supplies the detected signal to the computer board 40.

The brake board 60 has a function to brake the rotation of the electric motor 20, and comprises a combination of semiconductor relays and mechanical relays, so that it produces low switching noise and has a long service life.

The power supply circuit 62 generates DC electric energy from AC electric energy. The power supply circuit 62 generates low voltages for logic circuits used on the computer board 40, the monitoring board 42, and the interface board 58, and supplies the generated low voltages to those logic circuits. The power supply circuit 62 also generates a voltage of 24 [V] used in the display monitor 46 and supplies the generated voltage to the display monitor 46.

The control console 22 is also connected to a load sensor (not shown) which detects the load of cargo carried in the elevator car 12, an earthquake detection sensor (not shown), etc.

As shown in FIG. 3, the computer board 40 comprises various components connected to a bus 80 which are controlled by a microcomputer 82. The microcomputer 82 has a ROM (Read Only Memory) 84 and operates according to a program 86 stored in the ROM 84. The computer board 40 has a first communication circuit 88 for performing communications with the elevator car control board 64 and the floor control boards 68, a second communication circuit 90 for performing communications with the display monitor 46, and a third communication circuit 92 for performing communications with the interface board 58. The first, second, and third communication circuits 88, 90, 92 perform serial communications or data transmission, and hence require a reduced number of communication harnesses. The computer board 40 also has a RAM 94 for temporarily storing data used by the microcomputer 82, a flash memory 96 for retaining data even when the computer board 40 is switched off, a counter 98 for counting the signal from the encoder 30, and a clock 100 for supplying a clock signal to the microcomputer 82.

The counter 98 is capable of counting signals at high speeds, and can accurately count the speed and position (height) of the elevator car 12 in a wide range of speeds, from low to high speeds, of the elevator car 12. Each of the RAM 94 and the flash memory 96 has a storage capacity large enough to store control data and failure data.

The computer board 40 with the above components is applicable to various buildings ranging from low-rise to high-rise buildings, and is also applicable to electric motors of various types operable at various elevating and lowering speeds ranging from low to high speeds. Specifically, the computer board 40 can handle maximum elevating and lowering speeds including, as reference values, 30, 45, 60, 90, 105, 120, 150, 180, 210, 240, 360, and 600 [m/min].

The computer board 40 is thus applicable to various elevator systems and can be shared by various elevator systems, so that an inventory of parts required to manufacture those elevator systems is reduced. Since the single computer board 40 is able to control the elevator system in a wide range of speeds from low to high speeds, the control console 22 is simplified in structure.

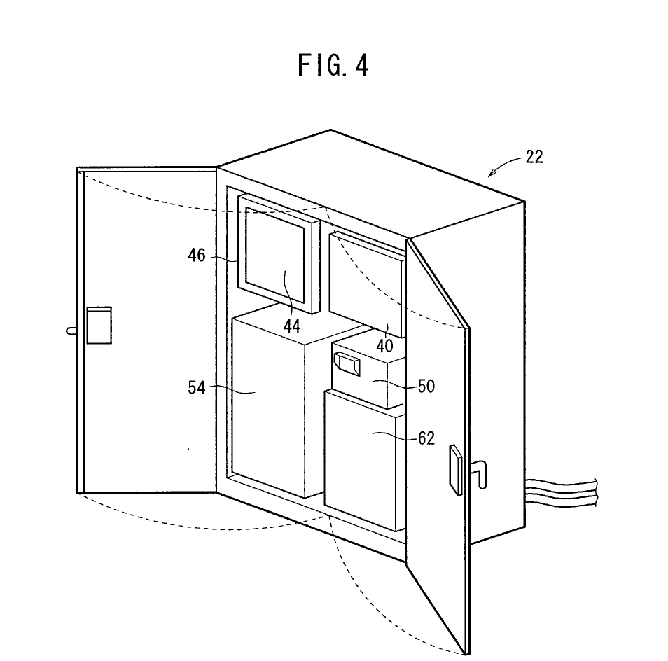

As shown in FIG. 4, the control console 22 is of a cubicle structure, and has the display monitor 46, the circuit breaker 50, the inverter 54, and the power supply circuit 62 positioned immediately behind front doors thereof for easy access and operation for the maintenance of the elevator system. Other devices of the control console 22, such as the interface board 58, are disposed behind the above devices. The devices in the control console 22 should preferably be of a dust- and drip-proof structure. Specifically, if the devices in the control console 22 are arranged to satisfy the standard values IP64 (see JIS-B6015), then they are highly reliable against dust and water condensation.

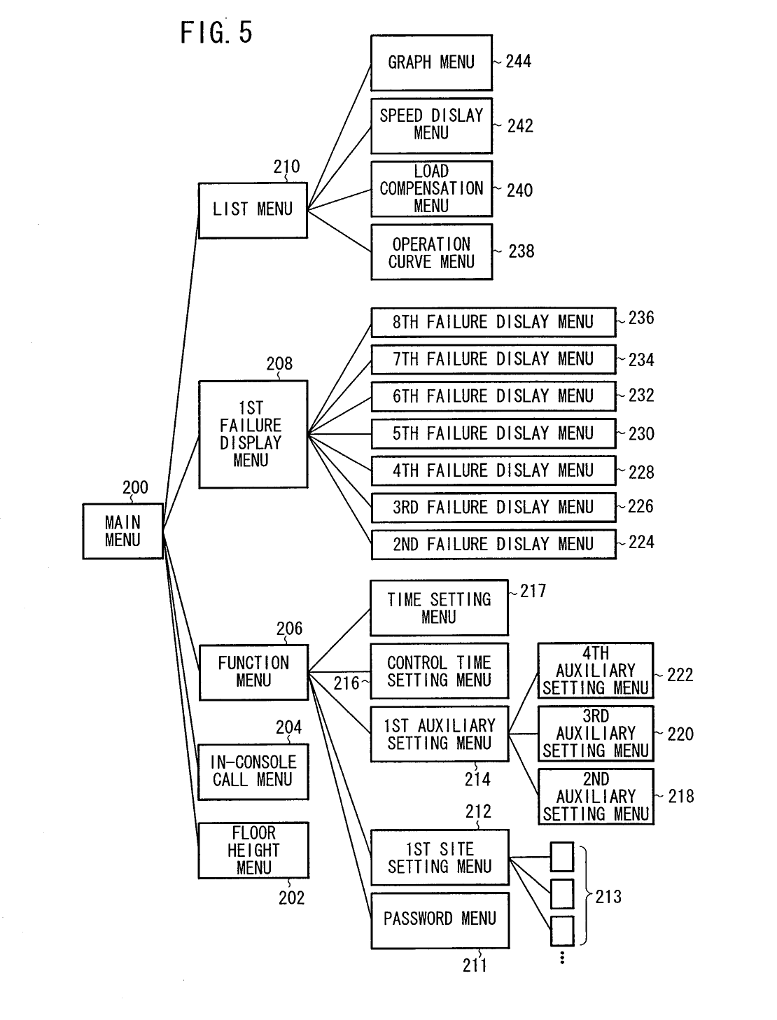

Various menus displayed on the monitor screen 44 of the display monitor 46 under the control of the computer board 40 will be described below with reference to FIGS. 5 through 21. In the example given below, the elevator system 10 is incorporated in a 16-story building.

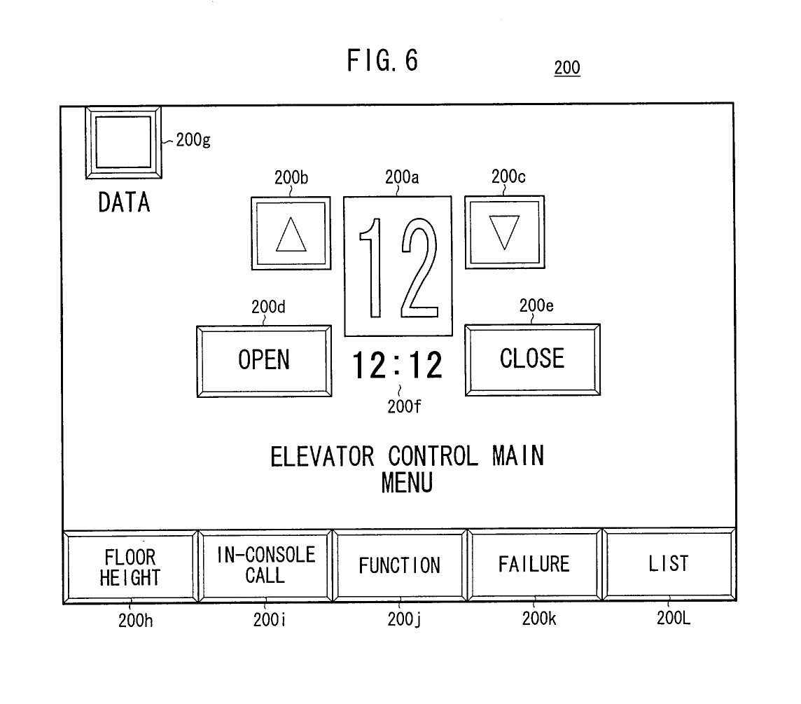

As shown in FIG. 5, the menus displayed on the monitor screen 44 (see FIG. 4) are arranged in a hierarchy with a main menu 200 (see also FIG. 6) on a highest level. A menu displayed on the monitor screen 44 changes to another menu when the operator touches a button displayed in the menu. Buttons displayed in each of the menus are simulated buttons, which give commands to the microcomputer 82 when touched by the operator.

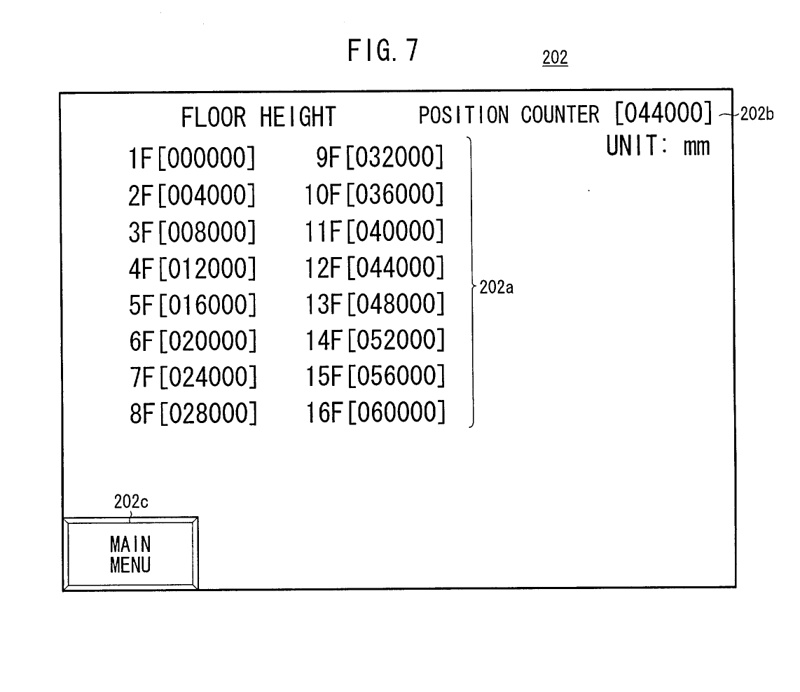

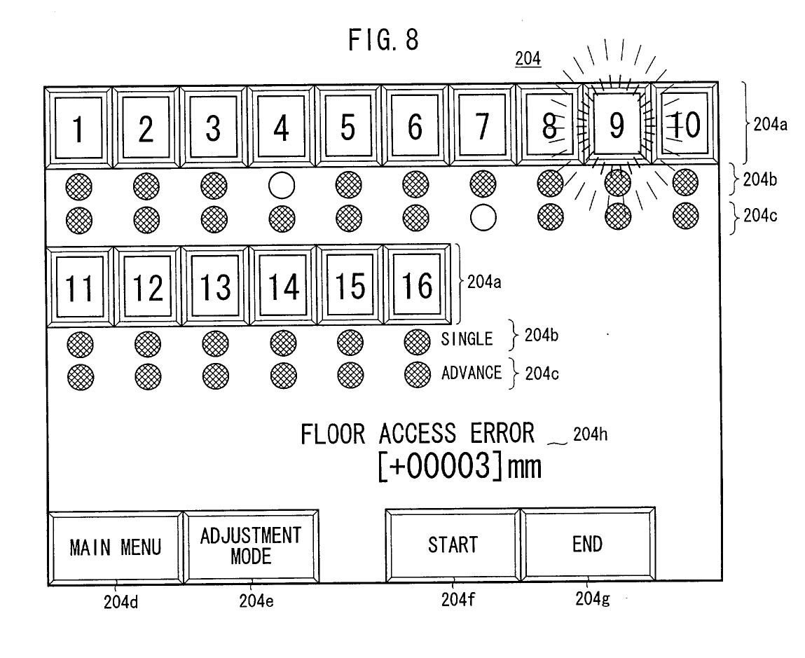

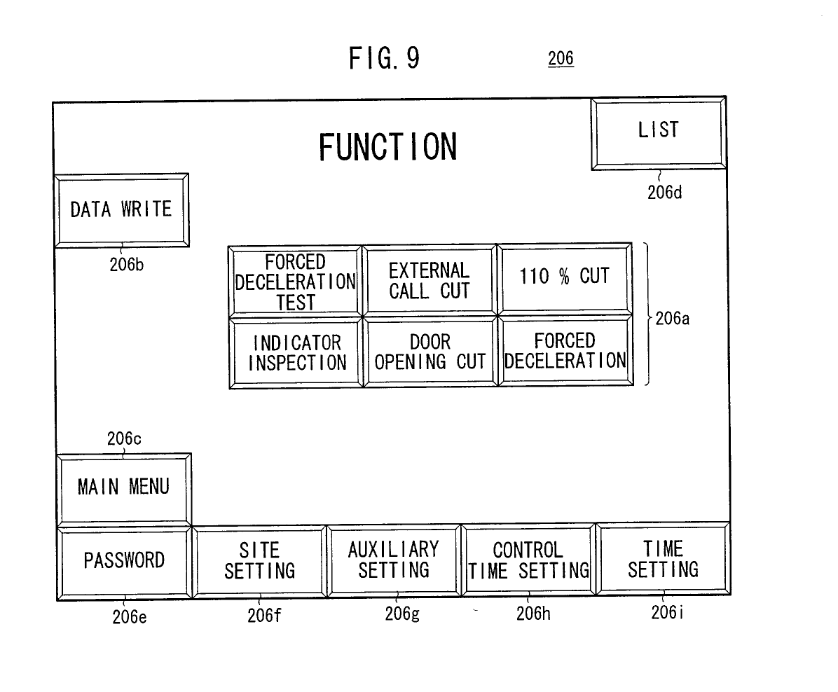

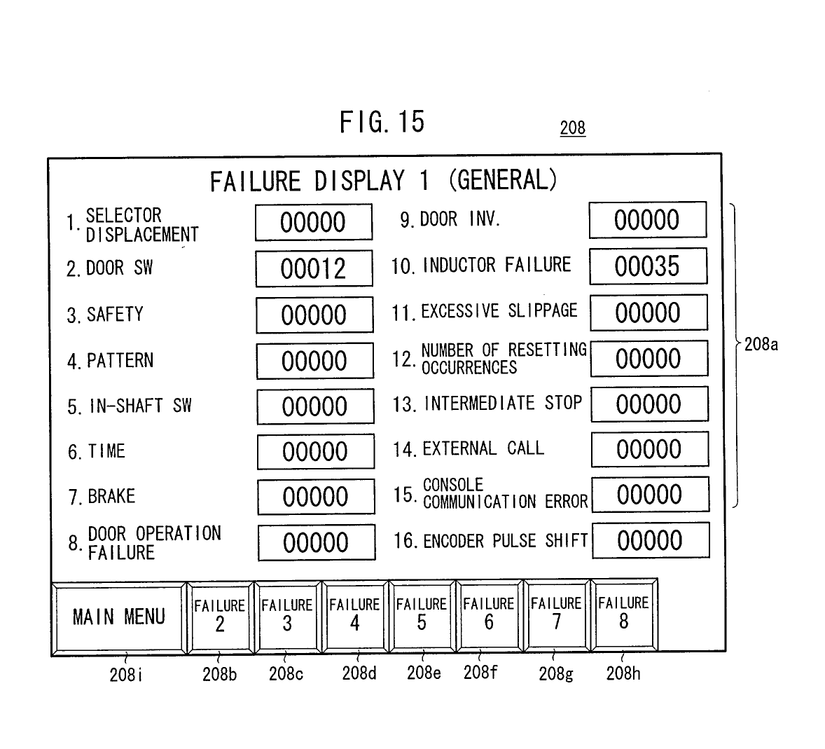

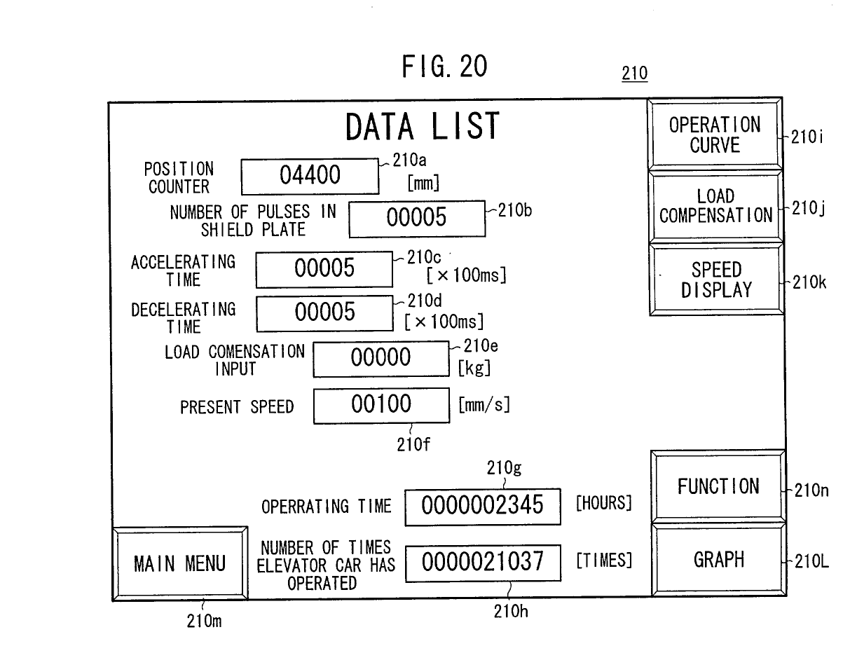

There are five menus in a layer directly beneath the main menu 200. Specifically, these menus include a floor height menu 202 (see also FIG. 7) for displaying the floor heights of respective floors, an in-console call menu 204 (see also FIG. 8) for allowing the operator to make operations similar to those on the elevator car control console 66, a function menu 206 (control data input menu, see also FIG. 9) for setting various functions, a first failure display menu 208 (detected data input menu, see also FIG. 15) for displaying failures, and a data list menu 210 (detected data display menu, see also FIG. 20) for displaying various data.

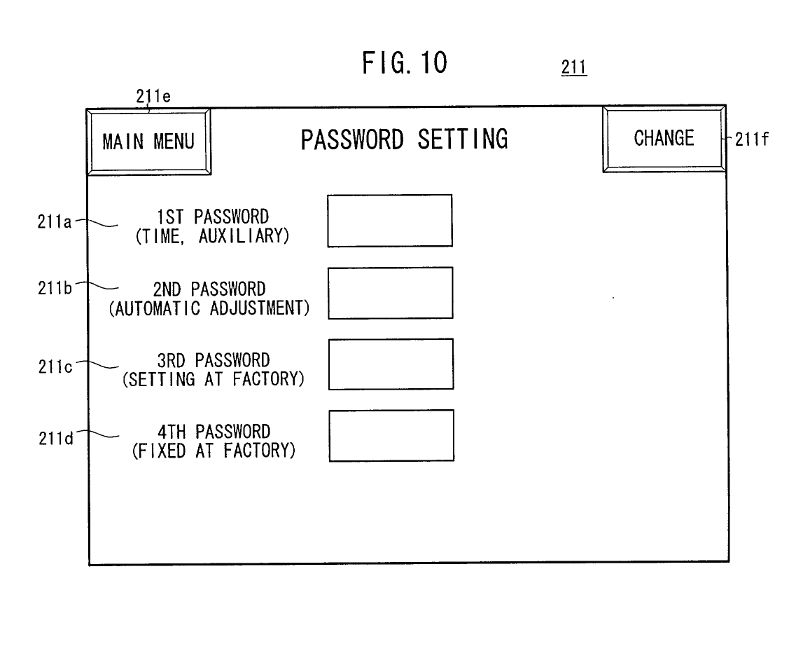

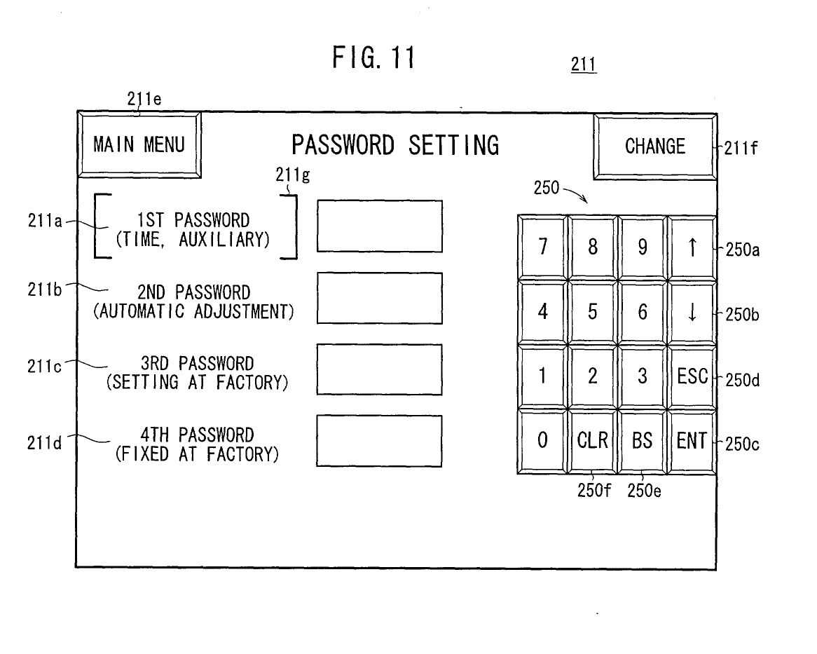

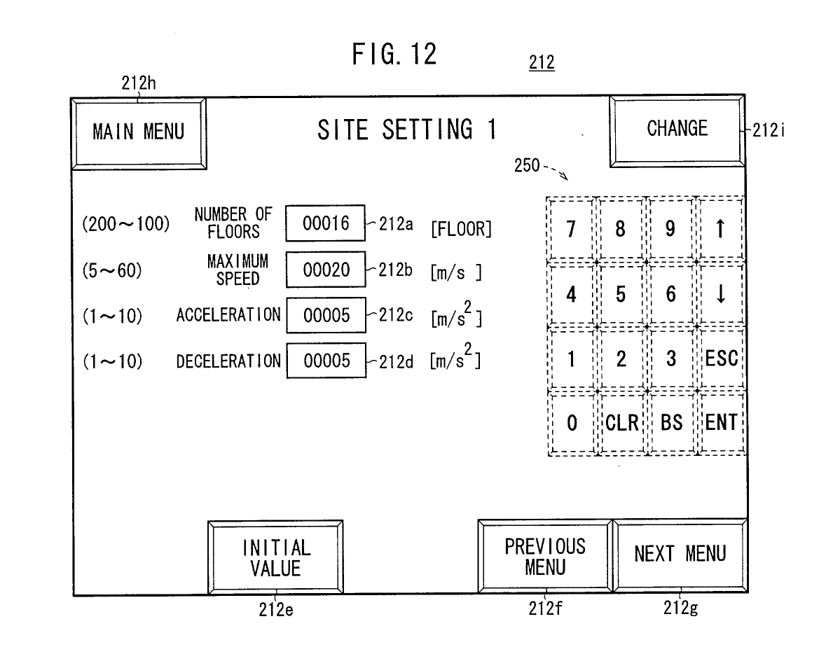

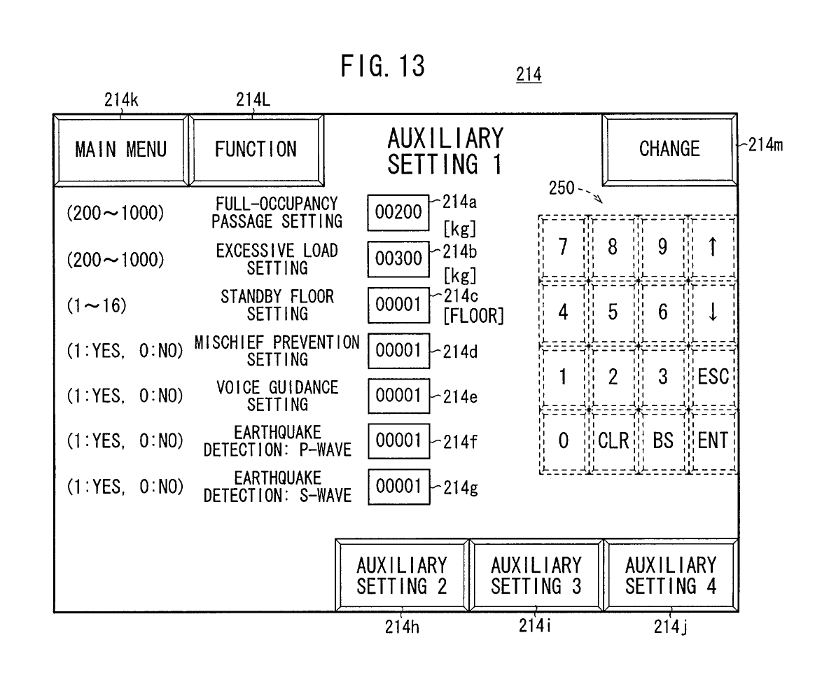

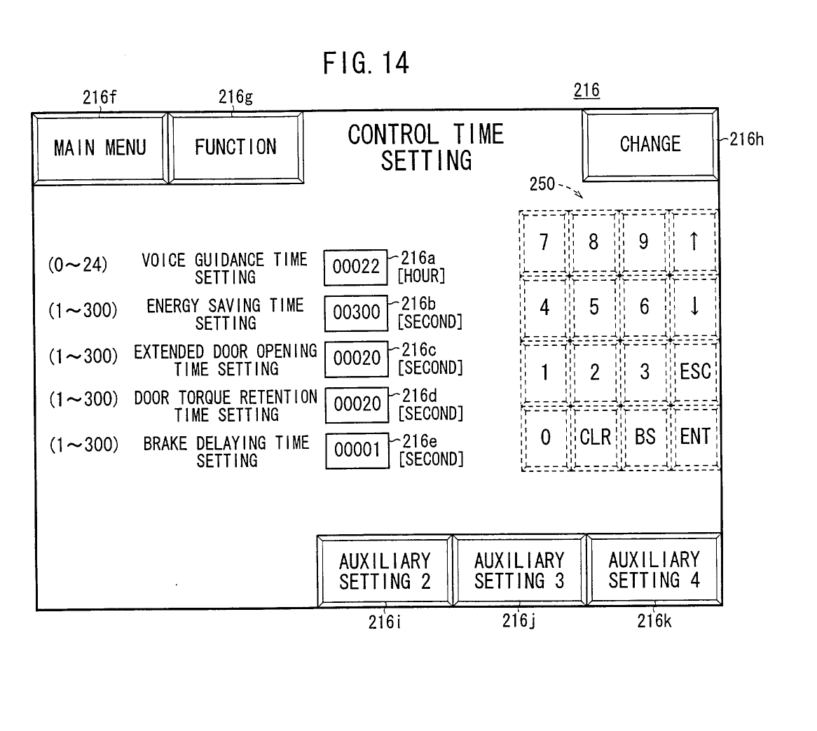

In a layer directly beneath the function menu 206, there are a password menu 211 (see also FIGS. 10 and 11) for setting a password, a first site setting menu 212 (control data input menu, see also FIG. 12) for being operated mainly by a maintenance person, a first auxiliary setting menu 214 (control data input menu, see also FIG. 13) for making auxiliary settings, a control time setting menu 216 (control data input menu, see also FIG. 14) for setting control times relating to operation of the elevator system, and a time setting menu 217 (control data input menu) for setting a time for the clock 100 (see FIG. 3).

There are a plurality of auxiliary setting menus 213 in a layer directly beneath the first site setting menu 212, and second through fourth auxiliary setting menus (control data input menus) 218, 220, 222 in a layer directly beneath the first auxiliary setting menu 214.

There are second through eighth failure display menus (detected data display menus) 224, 226, 228, 230, 232, 234, 236 in a layer directly beneath the first failure display menu 208.

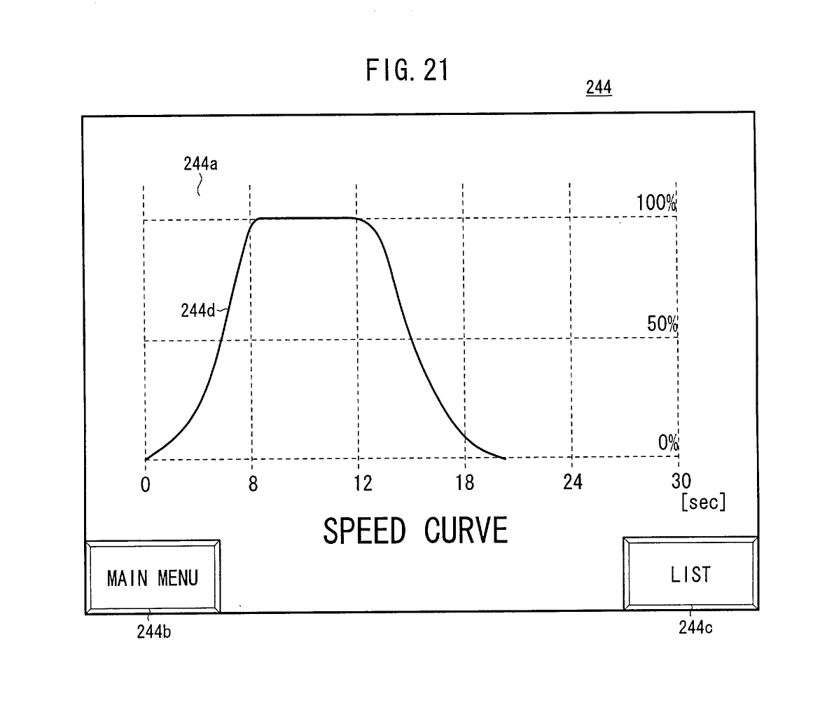

In a layer directly beneath the data list menu 210, there are an operation curve menu 238 for displaying data relating to operation of the elevator car 12, a load compensation menu 240 for displaying information as to the load on the elevator car 12, a speed display menu 242 for displaying data as to the operational speed, and a graph menu 244 (see also FIG. 21) for displaying an actual elevating and lowering speed of the elevator car 12 in a graph form.

The display screen 44 also displays many other menus (not shown) for entering and displaying various data.

As shown in FIG. 6, the main menu 200 has a present floor display area 200a for displaying a floor where the elevator car 12 is presently positioned, an upward command button 200b for entering a command to move the elevator car 12 to a higher floor, a downward command button 200c for entering a command to move the elevator car 12 to a lower floor, a door opening button 200d for opening the car doors 26 (see FIG. 1), a door closing button 200e for closing the car doors 26, a time display area 200f for displaying a present time based on the data of the clock 100 (FIG. 3), and a data ready display area 200g for displaying whether there is data or not.

The main menu 200 also has a floor height button 200h for calling the floor height menu 202 (see FIG. 7), a in-console call button 200i for calling the in-console call menu 204 (see FIG. 8), a function button 200j for calling the function menu 206 (see FIG. 9), a failure button 200k for calling the first failure display menu 208 (see FIG. 15), and a data list button 200L for calling the data list menu 210 (see FIG. 20).

Since the operator can give commands for basic operations of the elevator car 12 in the main menu 200, the operator can confirm those basic operations of the elevator car 12 in the main menu 200. The operator can easily change displayed menus by touching the call buttons displayed at the bottom of the main menu 200, i.e., the floor height button 200h, the in-console call button 200i, the function button 200j, the failure button 200k, and the data list button 200L.

As shown in FIG. 7, the floor height menu 202 has a floor height data display area 202a for displaying entered heights of the respective floors, a position counter 202b for displaying a present height of the elevator car 12, and a main menu button 202c for calling the main menu 200.

The operator can confirm an accurate present height of the elevator car 12 based on a value displayed by the position counter 202b.

As shown in FIG. 8, the in-console call menu 204 has a plurality of destination buttons 204a corresponding to the respective floors, a single floor display area 204b for displaying a present floor where the elevator car 12 is positioned, and an advance floor display area 204c for displaying a floor where the elevator car 12 can be stopped. The in-console call menu 204 also has a main menu button 204d for calling the main menu 200, an adjustment mode button 204e for entering an automatic adjustment mode, a start button 204f and an end button 204g which are displayed when the elevator system 10 has entered the automatic adjustment mode, and a floor access error display area 204h for displaying a floor access error from a reference position when the elevator car 12 is stopped at each floor.

The destination buttons 204a are buttons which can be touched by the operator for indicating a destination floor for the elevator car 12. The elevator car 12 is elevated or lowered depending on the destination floor indicated by one of the destination buttons 204a which is touched by the operator. As the elevator car 12 is elevated or lowered, the position of the elevator car 12 is displayed by the single floor display area 204b, and a floor where the elevator car 12 can be stopped is displayed by the advance floor display area 204c. Specifically, one of the circular marks of the single floor display area 204b and one of the circular marks of the advance floor display area 204c are turned into white circular marks, indicating the present floor where the elevator car 12 is positioned and the floor where the elevator car 12 can be stopped, respectively. In the example shown in FIG. 8, the destination floor is the ninth floor, and the elevator car 12 is being elevated in the vicinity of the fourth floor. Since the advance floor display area 204c has a white circular mark at the seventh floor, the destination buttons 204a for the fifth and sixth floors are invalid. Because the elevator car 12 can be stopped at the seventh and eighth floors at this time, the operator can stop the elevator car 12 at the seventh floor or the eighth floor by touching the destination button 204a for the seventh floor or the eighth floor.

The access error display area 204h serves to display a floor access error, i.e., a difference between the preset height of each floor and the present height of the elevator car 12. The floor access error should preferably be as small as possible.

When the operator touches the adjustment mode button 204e, the elevator system 10 enters the automatic adjustment mode, and the start button 204f and the end button 204g are displayed. When the operator touches the start button 204f, the automatic adjustment mode is started. In the automatic adjustment mode, the elevator car 12 is repeatedly elevated and lowered to arbitrary floors, and preferred operating conditions are established while measuring floor access errors. While the elevator system 10 is in the automatic adjustment mode, the floor access errors are displayed in the access error display area 204h. After the operator has confirmed that the floor access errors become sufficiently small, the operator touches the end button 204g. The automatic adjustment mode is now finished, and the start button 204f and the end button 204g disappears from the in-console call menu 204.

As shown in FIG. 9, the function menu 206 has a plurality of test buttons 206a for conducting various inspections and tests, a data write button 206b for writing data, a main menu button 206c for returning to the main menu 200, and a list button 206d for calling the data list menu 210. The function menu 206 also has a password button 206e for calling a menu in a lower layer, a site setting button 206f, an auxiliary setting button 206g, a control time setting button 206h, and a time setting button 206i. When the operator touches these buttons, the password menu 211, the first site setting menu 212, the first auxiliary setting menu 214, the control time setting menu 216, and the time setting menu 217 are called.

As shown in FIG. 10, the password menu 211 has four password input areas, i.e., a first password input area 211a, a second password input area 211b, a third password input area 211c, and a fourth password input area 211d. The password menu 211 also has a main menu button 211e for returning to the main menu 200 and a mode button 211f for setting a mode for changing the password. The mode button 211f has “CHANGE” displayed in an initial state.

A first password in the first password input area 211a is a password primarily for the building keeper, and used to display and permit the user to access the control time setting menu 216, for example.

A second password in the second password input area 211b is a password primarily for the maintenance person, and used to display and permit the user to access the first failure display menu 208, in-console call menu 204, for example.

A third password in the third password input area 211c is a password for making settings upon shipment of the elevator system 10 in the factory, and permit the number of floors of the building, the heights of the floors, etc. to be inputted.

A fourth password to be entered in the fourth password input area 211d is a password used by the system developer, and permits the developer to change values inherent in the control of the elevator system 10.

The first through fourth passwords gives different levels of access right to the user. The access right by the second password is greater than the access right by the first password. The access right by the third password is greater than the access right of the second password. The access right by the fourth password is greater than the access right of the third password. When the fourth password is properly entered, the user can access all menus and perform all the operations which are permitted by the first through fourth passwords. When the third password is properly entered, the can access menus that are permitted by first through three passwords, and can perform operations which are permitted by first through third passwords.

Since the access to the menus is limited by the first through fourth passwords, it is possible to prevent unauthorized operations in the menus.

When the operator touches the mode button 211f in the password menu 211 shown in FIG. 10, the password menu 211 shown in FIG. 10 changes to a password change mode menu shown in FIG. 11. In the password change mode menu, the mode button 211f has “CHANGE” displayed, and a ten-key pad 250 including numerical keys which are virtual numerical buttons “0” through “9” and an input cursor 211g in the shape of brackets are displayed.

The operator moves the input cursor 211g vertically with an up cursor key 250a and a down cursor key 250b in the ten-key pad 250, and selects one of the first through fourth password input areas 211a through 211d for a password to be entered or changed. After the operator enters a password into the selected area using the numerical buttons “0” through “9”, the operator touches an ENT (Enter) key 250c to determine the entered value. The entered value may be canceled by touching an ESC (Escape) key 250d when the password is indicated in the selected area. When the password is indicated in the selected area, the cursor can be moved back, deleting one character at a time, each time a BS (Back Space) key 250e is touched, and all the entered value may be cleared by touching a CLR (Clear) key 250f. After the password is entered, the operator touches the mode button 211f, ending the password change mode and returning to the password menu 211 shown in FIG. 10.

The mode button 211f is a common button used in the menus for setting various data. For example, a mode button 212i in the first site setting menu 212 (see FIG. 12), a mode button 214m in the first auxiliary setting menu 214 (see FIG. 13), and a mode button 216h in the control time setting menu 216 (see FIG. 14) have the same function as the mode button 211f. Specifically, when the operator touches these mode buttons 212i, 214m, 216h, the ten-key pad 250 is displayed, allowing the operator to enter numerical values in the same manner as described above.

The operator can thus enter data in the menus basically by operating the ten-key pad 250 including the numerical keys “0” through “9”. Since the ten-key pad 250 does not have alphabetical keys and symbol keys, it takes up a relatively small area in the menus, actually 1/2 or less of the entire area of the menus. Therefore, it is not necessary to use a device dedicated for entering data, such as a keyboard, and many items of information can be displayed in the menus.

As shown in FIG. 12, the first site setting menu 212 has a number-of-floors setting area 212a for setting the number of floors of the building to which the elevator system 10 is applied, a maximum speed setting area 212b for setting a maximum speed at which the elevator car 12 is elevated and lowered, an acceleration setting area 212c for setting an acceleration at the time the elevator car 12 starts moving, and a deceleration setting area 212d for setting a deceleration at the time the elevator car 12 stops moving. The first site setting menu 212 also has an initial value button 212e for resetting the values of the number of floors, the maximum speed, the acceleration, and the deceleration to default values, a previous menu button 212f and a next menu button 212g for changing to and from the auxiliary setting menus 213 (see FIG. 5), a main menu button 212h for returning to the main menu 200, and a mode button 212i for setting a mode for changing settings.

The operator touches the mode button 212i to display the ten-key pad 250, and operates the ten-key pad 250 to enter values in the number-of-floors setting area 212a, the maximum speed setting area 212b, the acceleration setting area 212c, and the deceleration setting area 212d. Ranges of numerical values that can be entered are displayed on the left ends of these setting areas 212a through 212d. If a numerical value outside of the ranges is entered, it is automatically rejected. Therefore, a wrong numerical value is prevented from being entered in these setting areas 212a through 212d. The displayed ranges allow the operator to confirm the ranges in which numerical values can be entered.

The auxiliary setting menus 213 in the layer directly beneath the first site setting menu 212 (see FIG. 5) correspond to second site setting menus, and allow the operator to set various data other than the number of floors, the maximum speed, the acceleration, and the deceleration.

As shown in FIG. 13, the first auxiliary setting menu 214 has a full-occupancy passage setting area 214a for setting a threshold weight used in a full-occupancy passage function, an excessive load setting area 214b for setting a threshold weight for stopping operation of the elevator system 10 when it is under an excessive load, a standby floor setting area 214c for setting a standby floor, a mischief prevention setting area 214d for selecting whether a mischief prevention function (e.g., a function to disable an operation made by a single passenger to press the destination buttons for all floors) is to be effective or ineffective, a voice guidance setting area 214e for selecting whether a voice guidance function for giving a voice guidance as to a floor to be reached next, a P-wave earthquake detecting area 214f for selecting whether a function to stop operation of the elevator system 10 in the event of a P-wave (longitudinal wave that oscillates in the same direction as the direction in which the wave is moving) is to be effective or ineffective, and an S-wave earthquake detecting area 214g for selecting whether a function to stop operation of the elevator system 10 in the event of an S-wave (transverse wave that oscillates perpendicularly to the direction in which the wave is moving) is to be effective or ineffective.

The first auxiliary setting menu 214 also has a plurality of call buttons 214h, 214i, 214j for calling the second through fourth auxiliary setting buttons 218, 220, 222, respectively, a main menu button 214k for returning to the main menu 200, a function button 214L for returning to the function menu 206, and a mode button 214m for setting a mode for changing settings.

When the operator touches the mode button 214m, the ten-key pad 250 is displayed, and the operator operates the ten-key pad 250 to enter settings. Ranges of numerical values that can be entered are displayed on the left ends of these setting areas 214a through 214c. If a numerical value outside of the ranges is entered, it is automatically rejected.

As shown in FIG. 14, the control time setting menu 216 has a voice guidance setting area 216a for setting a time to finish a voice guidance, an energy saving time setting area 216b for setting a time to enter in an energy saving mode such as for turning off the illumination in the elevator car 12 when the elevator car 12 is at rest, an extended door opening time setting area 216c for setting a time for which the car doors 26 and the floor doors 28 (see FIG. 1) remain open, a door torque retention time setting area 216d for setting a time for which a torque to close the car doors 26 and the floor doors 28 is retained, and a brake delaying time setting area 216e for changing a braking time to make fine adjustments to the comfort of the occupants of the elevator car 12 when the elevator car 12 is braked to a stop.

The control time setting menu 216 also has a main menu button 216f for returning to the main menu 200, a function button 216g for returning to the function menu 206, and a mode button 216h for setting a mode for changing settings.

When the operator touches the mode button 216h, the ten-key pad 250 is displayed, and the operator operates the ten-key pad 250 to enter settings. Ranges of numerical values that can be entered are displayed on the left ends of these setting areas 216a through 216e. If a numerical value outside of the ranges is entered, it is automatically rejected.

The control time setting menu 216 further has a plurality of call buttons 216i, 216j, 216k for calling the second through fourth auxiliary setting buttons 218, 220, 222, respectively, in the lower layer.

As shown in FIG. 15, the first failure display menu 208 has a plurality of failure display areas 208a for displaying the numbers of times that various failures detected by the computer board 40 have occurred, a plurality of call buttons 208b, 208c, 208d, 208e, 208f, 208g, 208h for calling the second through eighth failure display menus 224, 226, 228, 230, 232, 234, 236, respectively, in the lower layer, and a main menu button 208i for returning to the main menu 200.

The failure display areas 208a display the names of typical failures that occur in the elevator system 10, which can easily be understood by a general maintenance person. For example, “2. DOOR SW” represents a failure for floor doors 28 to be opened and closed. In the example shown in FIG. 15, the total number of opening and closing failures of the floor doors 28 on the floors ranging from the first floor to the sixteenth floor is “12”.

“10. INDUCTOR FAILURE” represents 35 failures of an inductor (not shown) which detects a floor reached by the elevator car 12.

The second through eighth failure display menus 224, 226, 228, 230, 232, 234, 236 are displayed when the call buttons 208b, 208c, 208d, 208e, 208f, 208g, 208h at the bottom of the first failure display menu 208 are touched. These failure display menus display the numbers of times that many failures have occurred and also display details of the data displayed in the first failure display menu 208.

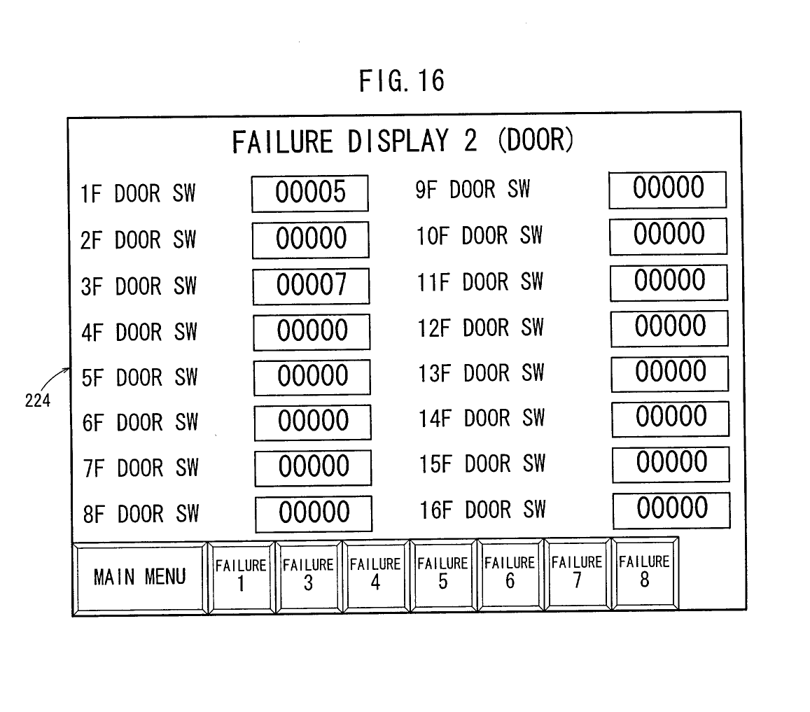

For example, FIG. 16 shows the second failure display menu 224 which displays failures of “2. DOOR SW” in the first failure display menu 208 at the respective floors. In the example shown in FIG. 16, the floor doors 28 on the first floor have suffered 5 failures, and the floor doors 28 on the third floor have suffered 7 failures.

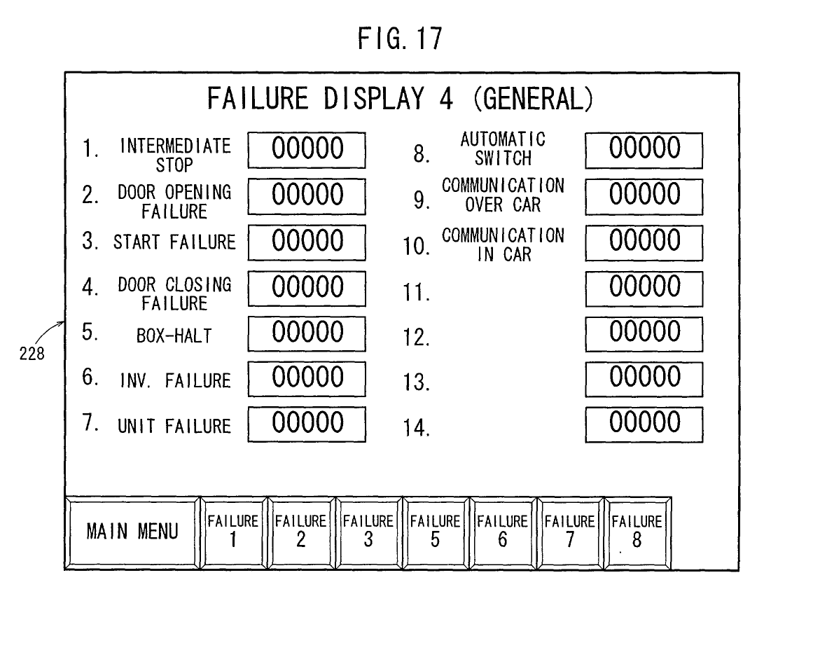

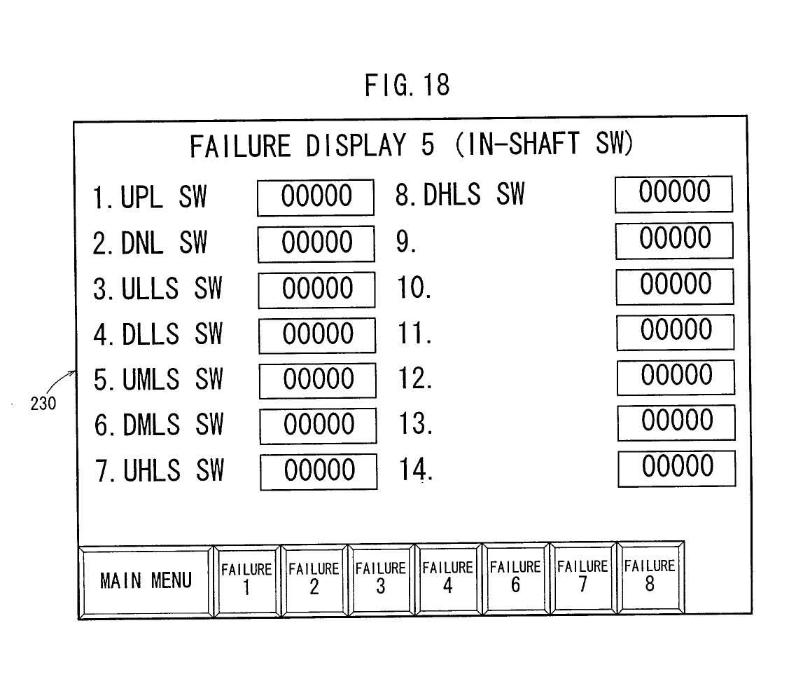

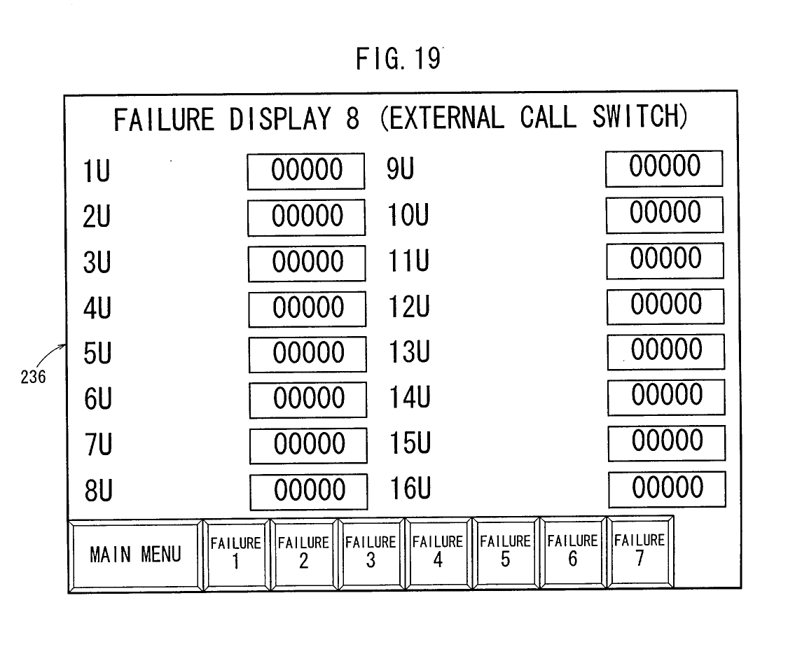

FIG. 17 shows the fourth failure display menu 228 which displays failures within the control console 22. FIG. 18 shows fifth failure display menu 230 which displays failures of various switches. For example, “1. UPL SW” represents a failure of an up limit switch. FIG. 19 shows the eighth failure display menu 236 which displays failures of the call buttons 72 (see FIG. 2) on the respective floors.

Since the first through eighth failure display menus 208, 224, 226, 228, 230, 232, 234, 236 can display the numbers of times that many failures have occurred, the maintenance person can quickly judge specific causes of those failures based on the displayed information.

The numbers of times that failures have occurred which are displayed in the first through eighth failure display menus 208, 224, 226, 228, 230, 232, 234, 236 can be reset to an initial value “0” by operating a small switch (not shown) mounted on the computer board 40 (see FIG. 4).

As shown in FIG. 20, the data list menu 210 has a position counter 210a for displaying a present height of the elevator car 12, a pulse display area 210b for displaying the number of pulses within a shield plate, an accelerating time display area 210c for displaying an actual accelerating time of the elevator car 12, a decelerating time display area 210d for displaying an actual decelerating time of the elevator car 12, a load compensation display area 210e for displaying a load compensation input value, and a present speed display area 210f for displaying a present speed of the elevator car 12. The data list menu 210 also has an operation time display area 210g for displaying an accumulated value of times for which the elevator car 12 has operated, and an operation count display area 210h for displaying the number of times that the elevator car 12 has operated.

The data list menu 210 further includes an operation curve button 210i for calling the operation curve menu 238, a load compensation button 210j for calling the load compensation menu 240, a speed display button 210k for calling the speed display menu 242, and a graph button 210L for calling the graph menu 244. The data list menu 210 also includes a main menu button 210m for returning to the main menu 200 and a function button 210n for calling the function menu 206.

As shown in FIG. 21, the graph menu 244 has a graph display area 244a for displaying the speed of the elevator car 12, as it varies with time, in a graph form, a main menu button 244b for returning to the main menu 200, and a list button 244c for returning to the data list menu 210. The graph display area 244a has a horizontal axis representing time and a vertical axis representing elevating and lowering speeds of the elevator car 12. The elevating and lowering speeds of the elevator car 12 are displayed as a graph 244d by a given trigger signal. The graph 244d allows the operator to confirm the elevating and lowering movement of the elevator car 12, and in particular to judge the riding comfort with the elevator car 12 at the time the elevator car 12 is accelerated and decelerated. The graph display area 244a may also display the acceleration and deceleration of the elevator car 12.

Inasmuch as the menus displayed on the monitor screen 44 are of a hierarchical structure, it is easy to go to a desired menu among those menus. When the operator has finished operations made in all menus in the layers, the operator can return to the main menu 200 as an initial menu by touching the main menu button, e.g., the main menu button 202c shown in FIG. 7. It is easy to change between menus other than between menus in upper and lower layers because there are buttons for calling related menus. For example, the data list menu 210 can be called by touching the list button 206d in the function menu 206 shown in FIG. 9.

A process of operating and controlling the elevator system 10 thus constructed will be described below.

The circuit breaker 50 (see FIG. 2) is switched on to start operating the elevator system 10. The power supply circuit 62 generates a plurality of DC voltages to be used in the control console 22 from the power supply 48, and supplies the generated DC voltages to the devices in the control console 22. Usually, the circuit breaker 50 remains switched on.

When the computer board 40 (FIG. 3) is energized, the microcomputer 82 starts to operate according to the program 86 and controls the control console 22 and the elevator system 10.

The display monitor 46 which displays menus under the control of the microcomputer 82 displays the main menu 200 (see FIG. 6) as an initial menu.

Then, an adjustment operator enters control data indispensable for the elevator system 10. The indispensable control data are data of specifications of the building in which the elevator system 10 is incorporated, and specifically represent the number of floors of the building, the maximum speed of the elevator car 12, the acceleration and deceleration of the elevator car 12, the heights of the floors, etc.

For example, for setting the number of floors of the building, the adjustment operator touches the site setting button 206f in the function menu 206 to call the first site setting menu 212. At this time, since the adjustment operator is required to confirm a password, the adjustment operator enters the third password to permit the first site setting menu 212 to be operated upon. In the first site setting menu 212, the adjustment operator touches the mode button 212i to display the ten-key pad 250 (see FIG. 11), and operates the ten-key pad 250 to enter the number of floors of the building, etc. The entered data are recorded in the flash memory 96 (see FIG. 3), so that they will not be erased even in the event of a power system failure. Basically, other entered data and failure data are recorded in the flash memory 96.

The adjustment operator also sets various data in the first auxiliary setting menu 214 (see FIG. 13) and sets a time in the time setting menu 217 (see FIG. 5) for time adjustment.

Then, the adjustment operator starts the automatic adjustment mode for the elevator system 10. Specifically, the adjustment operator touches the in-console call button 200i in the main menu 200, calling the in-console call menu 204 (see FIG. 8). Since the adjustment operator is required to confirm a password at this time, the adjustment operator enters the third password to permit the in-console call menu 204 to be operated upon.

In the in-console call menu 204, the adjustment operator touches the adjustment mode button 204e and the start button 204f successively to start the automatic adjustment mode, elevating and lowering the elevator car 12. When the floor access error displayed in the floor access error display area 204h is converged to a sufficiently small value, the adjustment operator touches the end button 204g to put the automatic adjustment mode to an end. Thereafter, the adjustment operator touches the main menu button 204d to return to the main menu 200. Data of operating conditions set in the automatic adjustment mode are recorded in the flash memory 96.

After the automatic adjustment mode, the graph menu 244 (see FIG. 21) may be displayed for the adjustment operator to confirm the elevating and lowering speeds of the elevator car 12.

Adjustments corresponding to the fourth password do not need to be made because the data corresponding to the fourth password are of design values inherent in the elevator system 10, and the elevator system 10 is normally operated according to initial values set in the ROM 84.

Then, after the necessary control data have been entered and the automatic adjustment mode has been ended, the elevator system 10 starts operating normally. The display monitor 46 is automatically brought into an energy saving sleep mode after elapse of a predetermined period of time.

While the elevator system 10 is operating normally, the control console 22 and the display monitor 46 do not need to be operated upon. Users of the elevator system 10 operate the elevator car control console 66 and the call buttons 72 (see FIG. 2), and the computer board 40 which has recognized these operations moves the motor 20, the car doors 26 and the floor doors 28 for thereby controlling the elevator system 10.

During normal operation of the elevator system 10, the computer board 40 detects various malfunctions or failures, and records the numbers of those failure occurrences in the flash memory 96. For example, the computer board 40 detects a failure of the switches 73 (see FIG. 2) on the respective floors, counts up the number of such failure occurrences, and records the count in the flash memory 96.

The computer board 40 also detects malfunctions or failures that have occurred in the control console 22, e.g., in the inverter 54 and the interface board 58, and records the number of such failure occurrences in the flash memory 96.

The computer board 40 issues a warning and performs a related process such as an elevator system shutdown for major ones of these failures, and records the number of failure occurrences and continuously operate the elevator system 10 for minor ones of these failures.

At the time of maintenance of the elevator system 10, the maintenance person touches the failure button 200k in the main menu 200 to call the first failure display menu 208 (see FIG. 15). At this time, since the maintenance operator is required to confirm a password, the maintenance operator enters the second password to permit the first failure display menu 208 to be operated upon.

In the displayed first failure display menu 208, the maintenance person determines whether there is a failure or not. If the number of failure occurrences is displayed in “2. DOOR SW” as shown in FIG. 15, then the maintenance person can recognize the floor on which the switch 73 has failed, and specifies the floor with the failure by confirming the second failure display menu 224 (see FIG. 16). Since the maintenance person can identify a failure spot based on the information displayed in the first through eighth failure display menus 208, 224, 226, 228, 230, 232, 234, 236, the maintenance person can quickly service the elevator system 10.

The number of occurrences of each type of failure is displayed, the maintenance person can judge how urgent it is to make a repair to remove the failure. Specifically, if a failure is small one and the number of occurrences of the failure is small (e.g., one occurrence), then since it does not adversely affect the operation of the elevator system 10, reparatory preparations may be made and a repair may be made in a next maintenance event.

After a repair has been made, the failure count recorded in the flash memory 96 is reset by operating the small switch mounted on the computer board 40 (see FIG. 4).

The maintenance person may confirms control data entered in the floor height menu 202 (see FIG. 7), the data list menu 210 (see FIG. 20), and the menus in the lower layer, and the operating state of the elevator car 12.

Then, a procedure for the building superintendent (or keeper) to change elevator system settings will be described below. With the conventional elevator system, it is difficult for the building superintendent to change settings of the elevator system. However, it is preferable for the building superintendent to be able to change energy saving operating time, the time setting, etc. The elevator system 10 according to the present invention allows the building superintendent to change elevator system settings as follows:

The building superintendent touches the monitor screen 44 of the display monitor 46, for example, in the sleep mode to display the last menu again.

The building superintendent then confirms the time display area 200f (see FIG. 6) in the main menu 200. If the displayed time suffers an error, then the building superintendent calls the time setting menu 217 (see FIG. 5) and sets a time therein. Since the building superintendent is required to confirm a password at this time, the building superintendent enters the first password to permit the time setting menu 217 to be operated upon, and then sets a time therein. For example, in a country with the summer time, the building superintendent may adjust the time function at the time the summer time is carried out. The building superintendent can adjust the time function without the need for the adjustment person or maintenance person from the elevator system manufacturer to go to the site.

For setting a given control time, the building superintendent touches the control time setting button 206h in the function menu 206 to call the control time setting menu 216 (see FIG. 14). Since the building superintendent is required to confirm a password at this time, the building superintendent enters the first password to permit the time setting menu 217 to be operated upon. In the control time setting menu 216, settings can be made in the voice guidance setting area 216a, the energy saving time setting area 216b, the extended door opening time setting area 216c, the door torque retention time setting area 216d, and the brake delaying time setting area 216e.

Inasmuch as the voice guidance setting area 216a can set a time to end a voice guidance, the time to end the voice guidance function can be set in timed relation to the time when the business of tenants of the buildings is ended each day. The time to end the voice guidance function is set based on the time of the clock 100 (see FIG. 3) which has been adjusted in the time setting menu 217.

The energy saving time setting area 216b can set a time to enter in the energy saving mode such as for turning off the illumination in the elevator car 12 when the elevator car 12 is at rest. Therefore, the elevator system 10 can operate according to an energy saving plan of the building.

The settings in the extended door opening time setting area 216c, the door torque retention time setting area 216d, and the brake delaying time setting area 216e may be varied for building management reasons and preferable riding comfort with the elevator car 12.

The elevator system 10 is not limited to use in the 16-story building, but may be used in buildings with more stories. If elevator system 10 is incorporated in buildings with 17 or more stories and not all floors can be displayed in one menu (e.g., the floor height menu 202 in FIG. 7), then the floors may be displayed in a plurality of divided menus.

The elevator system 10 is not limited to the single elevator car 12, but may have a plurality of elevator cars 12. The monitor screen 44 may display a hierarchical system of menus, flowcharts, and help messages for assisting the operator in operating the menus shown in FIG. 5. Data may be entered in the menus according to a selective answer format using “YES”, “NO”, etc. in reply to questions presented in the menus.

Although a certain preferred embodiment of the present invention has been shown and described in detail, it should be understood that various changes and modifications may be made therein without departing from the scope of the appended claims.

What is claimed is:

1. An elevator system comprising:
an electric motor for raising and lowering an elevator car;
an operating state detector for detecting an operating state of a system including said elevator car;
a controller for controlling said electric motor and converting a signal detected by said operating state detector into detected data; and
a display monitor either connected to or disposed in said controller, for displaying said detected data and entering control data used by said controller;
said control data being entered by a touch panel function or a pointing device function of said display monitor.

2. An elevator system according to claim 1, wherein said display monitor selectively displays on a monitor screen thereof a plurality of detected data display menus for displaying said detected data.

3. An elevator system according to claim 1, wherein said display monitor selectively displays on a monitor screen thereof a plurality of control data input menus for entering said control data.

4. An elevator system according to claim 2, wherein said detected data includes failure data, said detected data display menu displaying the names of types of failures represented by said failure data and the number of occurrences of the failures.

5. An elevator system according to claim 1, wherein said detected data comprises at least one of a position of said elevator car, a speed of said elevator car, an acceleration of said elevator car, a deceleration of said elevator car, a floor access error of said elevator car, the number of times that said elevator car has operated, and a period of time for which said elevator car has operated.

6. An elevator system according to claim 1, wherein said control data comprises at least one of a full-occupancy passage setting, an excessive load setting, a standby floor setting, a mischief prevention function setting, a voice guidance function setting, an earthquake detection setting, a maximum speed setting, an acceleration setting, a deceleration setting, an energy saving mode time setting, an extended door opening time setting, a door torque retention time setting, and a brake delaying time setting.

7. An elevator system according to claim 1, wherein said display monitor displays on a monitor screen thereof a speed curve of said elevator car in a graph form.

8. An elevator system according to claim 1, wherein said display monitor has a password input function to enter a password, and limits menus to be displayed or limits entering of said control data depending on a password which has been entered.

9. An elevator system according to claim 1, wherein said controller has a clock function, and performs different control processes depending on a time indicated by said clock function.

10. An elevator system according to claim 1, wherein said control data is entered using a ten-key pad including simulated numerical buttons “0” through “9”.

11. An elevator system according to claim 1, wherein said display monitor enters in an energy saving sleep mode in the absence of an input operation within a predetermined period of time.

12. An elevator system comprising:
an electric motor for raising and lowering an elevator car;
an operating state detector for detecting an operating state of a system including said elevator car;
a controller for controlling said electric motor and converting a signal detected by said operating state detector into detected data; and
a display monitor either connected to or disposed in said controller;
said controller having a computer board for controlling menus displayed on said display monitor and controlling a maximum elevating and lowering speed of said elevator car in a range from 30 to 600 [m/min] through rotation of said electric motor.

13. A method of controlling an elevator system including an electric motor for raising and lowering an elevator car, an operating state detector for detecting an operating state of a system including said elevator car, a controller for controlling said electric motor and converting a signal detected by said operating state detector into detected data, and a display monitor either connected to or disposed in said controller, said method comprising the steps of:
entering control data used by said controller;
rotating said electric motor based on said control data;
detecting an operating state of said elevator car; and
displaying said detected data on a monitor screen of said display monitor;
said step of entering control data comprising the step of entering the control data using a touch panel function or a pointing device function of said display monitor.
